(19) United States
(12) Patent Application Publication
(10) Pub. No.: US 2024/0021926 A1
(43) Pub. Date: Jan. 18, 2024

(54) Secondary Battery

(71) Applicant: SK ON CO., LTD., Seoul (KR)

(72) Inventors: Ji Hyung Kim, Daejeon (KR); Young Ha Kim, Daejeon (KR); Sang Bin Lee, Daejeon (KR); Ho Jin Hwang, Daejeon (KR)

(21) Appl. No.: 18/220,926

(22) Filed: Jul. 12, 2023

(30) Foreign Application Priority Data
Jul. 13, 2022 (KR) 10-2022-0086350

(51) Int. Cl. H01M 50/105; H01M 50/325

(52) U.S. Cl. CPC H01M 50/105; H01M 50/325

(57) ABSTRACT

A secondary battery includes an electrode assembly including a cathode and an anode, a pouch case including an accommodating portion in which the electrode assembly is placed and a peripheral portion extending along a circumference of the accommodating portion and sealing the electrode assembly, and an anti-venting tool coupled to at least one corner portion among corner portions of the peripheral portion to fix the corner portion. The corner portion is inserted through the anti-venting tool to protrude from the anti-venting tool.

### CROSS-REFERENCE TO RELATED APPLICATION

This application claims priority to Korean Patent Application No. 10-2022-0086350 filed Jul. 13, 2022, the disclosure of which is hereby incorporated by reference in its entirety.

### BACKGROUND OF THE INVENTION

### 1. Field of the Invention

The disclosure of the present patent document relates to a secondary battery. More particularly, the present disclosure relates to a pouch-type secondary battery.

### 2. Description of Related Art

A secondary battery which can be charged and discharged repeatedly is being applied to a mobile electronic device such as a mobile phone, a laptop computer, a PC. For example, a lithium secondary battery is actively developed and applied due to high operational voltage and energy density per unit weight, a high charging rate, a compact dimension, etc.

For example, the lithium secondary battery may include an electrode assembly including a cathode, an anode and a separation layer, and an electrolyte immersing the electrode assembly. The lithium secondary battery may further include a case for accommodating the electrode assembly and the electrolyte.

The case includes a pouch-type case, a can-type (cylindrical, prismatic, etc.) case, etc. For example, the pouch-type case may include an inner space capable of accommodating the electrode assembly and a sealing portion.

When a secondary battery is repeatedly charged and discharged or stored at a high temperature, a large amount of gas may be generated within an inside of the case. For example, a gas (e.g., HF) may be generated by a side reaction between the electrolyte and a cathode active material.

An inner pressure in the pouch-type case may be increased by the gas to result in exfoliation of components of the pouch-type case, deformation of an electrode, internal short circuit, explosion, venting, etc.

### SUMMARY OF THE INVENTION

According to an aspect of the present invention, there is provided a secondary battery having improved operational stability

A secondary battery includes an electrode assembly including a cathode and an anode, a pouch case including an accommodating portion in which the electrode assembly is placed and a peripheral portion extending along a circumference of the accommodating portion and sealing the electrode assembly, and an anti-venting tool coupled to at least one corner portion among corner portions of the peripheral portion to fix the corner portion. The corner portion is inserted through the anti-venting tool to protrude from the anti-venting tool.

In some embodiments, the anti-venting tool may be coupled to each of the corner portions.

In some embodiments, the peripheral portion may include a first side and a second side that are parallel to a long axis direction of the electrode assembly to face each other, and a third side and a fourth side that are parallel to a short axis direction of the electrode assembly to face each other. The anti-venting tool may cross two sides meeting each other among the first side to the fourth side in a planar direction.

In some embodiments, the peripheral portion may include a folding portion and a sealing portion, and the anti-venting tool may include a first anti-venting tool coupled to the sealing portion.

In some embodiments, the sealing portion may include a first sealing portion facing the folding portion, and a pair of second sealing portions connected to the folding portion and the first sealing portion. The first anti-venting tool may be coupled across the first sealing portion and the second sealing portion.

In some embodiments, the anti-venting tool may further include a second anti-venting tool coupled across the folding portion and the second sealing portion.

In some embodiments, a ratio of an area of the corner portion to an area of the accommodating portion in a planar direction may range from 0.02 to 0.15.

In some embodiments, the corner portion may have a triangle shape in a planar direction, and a minimum angle of the triangle may be in a range from 30° to 45°.

In some embodiments, a width of the anti-venting tool in a planar direction may be in a range from 1 mm to 10 mm.

In some embodiments, a height of the accommodating portion may be greater than a height of the anti-venting tool.

In some embodiments, the anti-venting tool may include an upper supporting portion, a lower supporting portion facing the upper supporting portion, and a connector connecting one end of the upper supporting portion and one end of the lower supporting portion. The corner portion may protrude while being sandwiched between the upper supporting portion and the lower supporting portion.

In some embodiments, the anti-venting tool may include an upper supporting portion, a lower supporting portion facing the upper supporting portion, a first connector connecting one end of the upper supporting portion and one end of the lower supporting portion, and a second connector connecting the other end of the upper supporting portion and the other end of the lower supporting portion. The corner portion may protrude while being sandwiched between the upper supporting portion and the lower supporting portion.

In some embodiments, the anti-venting tool may have a yield strength from 0.5 MPa to 500 MPa.

In some embodiments, the anti-venting tool may have a tensile modulus from 1 GPa to 500 GPa.

A secondary battery according to example embodiments of the present disclosure may include an anti-venting tool, so that venting may be suppressed during operation or storage at high temperature. Accordingly, life-span and operational stability of the secondary battery may be improved.

In some embodiments, the anti-venting tool having a specific shape may be coupled to a specific portion of a pouch case so that reduction of energy density of the secondary battery may be prevented.

### BRIEF DESCRIPTION OF THE DRAWINGS

FIG. 1 is a schematic perspective view of a secondary battery according to example embodiments.

FIG. 2 is a schematic plan view of a secondary battery according to example embodiments.

FIG. 3 is a cross-sectional view of a secondary battery taken along a line I-I′ of FIG. 1.

FIGS. 4 and 5 are perspective views schematically illustrating an anti-venting tool according to example embodiments.

FIG. 6 is a plan view of a secondary battery of Comparative Example 2.

### DESCRIPTION OF THE INVENTION

According to example embodiments disclosed in the present application, a secondary battery including an anti-venting tool and having improved operational stability is provided.

Hereinafter, embodiments of the present inventive concepts will be described in detail with reference to the accompanying drawings. However, those skilled in the art will appreciate that such embodiments described with reference to the accompanying drawings are provided to further understand the spirit of the present invention and do not limit subject matters to be protected as disclosed in the detailed description and appended claims.

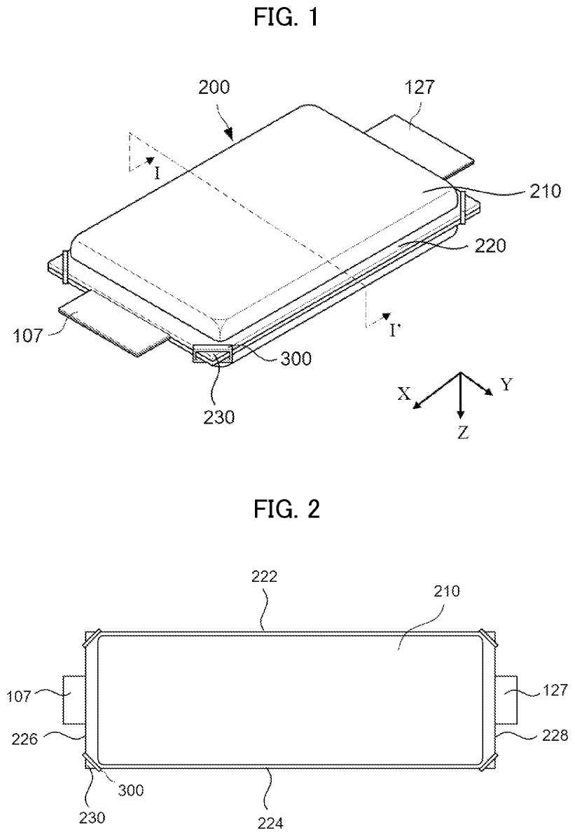

In the present specification, the term “planar direction” refers to a thickness direction of an electrode assembly or a direction in which cathodes and anodes are stacked (e.g., a Z-direction in FIG. 1).

In the present specification, the term “long axis direction” of the electrode assembly refers to a direction in which a long axis (or a long side) of the electrode assembly extends (e.g., an X-direction in FIG. 1). The term “short axis direction” of the electrode assembly refers to a direction in which a short axis (or a short side) of the electrode assembly extends (e.g., a Y-direction in FIG. 1).

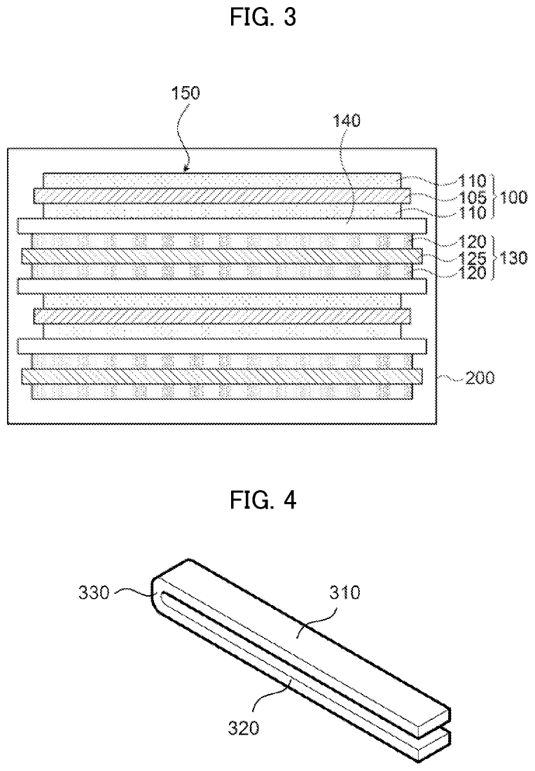

FIGS. 1 and 2 are a schematic perspective view and a schematic plan view, respectively, of a secondary battery according to example embodiments. FIG. 3 is a cross-sectional view of a secondary battery taken along a line I-I′ of FIG. 1.

Referring to FIGS. 1 to 3, the secondary battery may include an electrode assembly 150 and a pouch case 200 accommodating the electrode assembly 150. The secondary battery may be, e.g., a lithium secondary battery as a battery cell unit.

The pouch case 200 may include an accommodating portion 210 in which the electrode assembly 150 is placed, and a peripheral portion 220 extending along a circumference of the accommodating portion 210 and sealing the electrode assembly 150.

The peripheral portion 220 may include a corner portion 230. For example, as illustrated in FIGS. 1 and 2, the peripheral portion 220 may include a plurality of corner portions.

According to example embodiments of the present invention, the secondary battery may include an anti-venting tool 300 coupled to at least one of a plurality of the corner portions to fix the corner portion 230.

The corner portion 230 may be inserted into the anti-venting tool 300 to protrude therefrom. For example, the corner portion 230 may pass through the anti-venting tool 300.

When the secondary battery is repeatedly charged and discharged or stored at a high temperature, a large amount of a gas may be generated at an inside of the pouch case 200. The gas may increase an inner pressure in the pouch case 200 to cause a venting in which the peripheral portion (i.e., a sealing portion) of the pouch case is damaged. The venting may easily occur at the corner portion of the pouch case 200.

According to exemplary embodiments of the present disclosure, the venting may be suppressed by the anti-venting tool 300. Accordingly, life-span and operational stability of the secondary battery may be improved. Additionally, the anti-venting tool 300 may be coupled to a portion (i.e., the corner portion) of the peripheral portion 220 in the above-described shape, so that reduction of energy density of the secondary battery may be prevented.

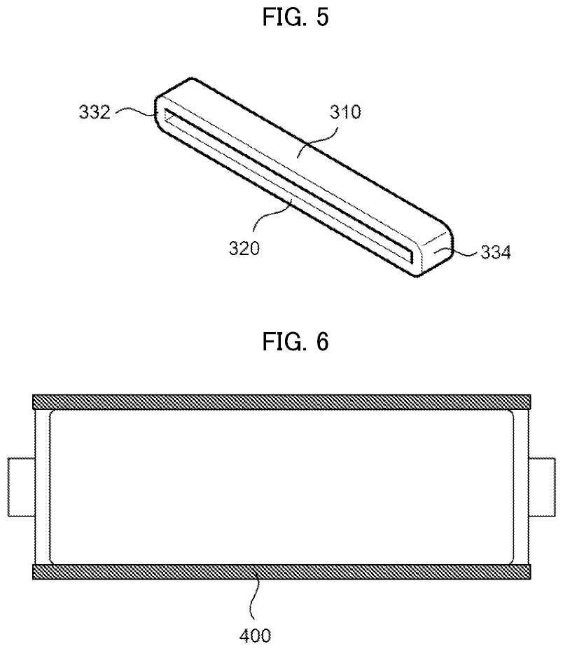

FIGS. 4 and 5 are perspective views schematically illustrating an anti-venting tool according to example embodiments.

Referring to FIG. 4, the anti-venting tool 300 may include an upper supporting portion 310, a lower supporting portion 320 facing the upper supporting portion 310, and a connector 330 that may connect one end of the upper supporting portion 310 and one end of the lower supporting portion 320 with each other.

In one embodiment, the upper supporting portion 310 and the lower supporting portion 320 may be spaced apart by a predetermined distance. In one embodiment, the upper supporting portion 310 and the lower supporting portion 320 may contact each other.

In the case that the upper supporting portion 310 and the lower supporting portion 320 may be separated by the predetermined distance, the corner portion 230 may be pushed and inserted between the upper supporting portion 310 and the lower supporting portion 320. Accordingly, the anti-venting tool 300 and the corner portion 230 may be coupled to each other.

In the case that a spacing distance is smaller than a thickness of the pouch case 200 or the upper supporting portion 310 and the lower supporting 320 are in contact with each other, the upper supporting portion 310 and the lower supporting portion 320 are further spaced apart from each other by an external force within a yield strength range, and then the corner portion 230 may be inserted therethrough. Thereafter, the upper supporting portion 310 and the lower supporting portion 320 may be elastically restored to fix the corner portion 230.

In some embodiments, an adhesive may be used on a bottom surface of the upper supporting portion 310 and a top surface of the lower supporting portion 320.

Referring to FIG. 5, the anti-venting tool 300 may include a first connector 332 and a second connector 334 connecting both ends of the upper supporting portion 310 and of the lower supporting portion 320. Accordingly, the venting suppression performance may be further improved.

In one embodiment, the anti-venting tool 300 may include a metallic material such as aluminum or stainless steel (SUS); or polymer material such as polyethylene (PE), polypropylene (PP), polystyrene (PS), polyvinyl chloride (PVC), polymethyl methacrylate (PMMA), an ABS resin, polyethylene terephthalate (PET), polybutylene terephthalate (PBT), polycarbonate (PC), acrylonitrile styrene (SAN), polyether ether ketone (PEEK), polyamide (PA), polyimide (PI), etc.

In one embodiment, the yield strength of the anti-venting tool 300 may be greater than an internal pressure in the accommodating portion 210 during a normal operation of the secondary battery. Accordingly, plastic deformation of the anti-venting tool 300 and loss of the venting suppression performance during the operation of the secondary battery may be prevented.

In some embodiments, the yield strength of the anti-venting tool 300 may be 0.5 MPa or greater, 1 MPa or greater, 5 MPa or greater, 10 MPa or greater, 20 MPa or greater, or 100 MPa or greater. In one embodiment, the yield strength of the anti-venting tool 300 may be 500 MPa or less, or 300 MPa or less.

In one embodiment, a tensile modulus of the anti-venting tool 300 may be 1 GPa or more, 2 GPa or more, 5 GPa or more, 10 GPa or more, or 50 GPa or more. Further, the tensile modulus of the anti-venting tool 300 may be 500 GPa or less, or 300 GPa or less. Within this range, the venting suppression performance may be improved.

The yield strength and the tensile modulus of the anti-venting tool 300 may be measured according to a standard corresponding to the material of the anti-venting tool 300. For example, if the material of the anti-venting tool 300 is metal, the yield strength and the tensile modulus may be measured according to ASTM E8/E8M. If the material of the anti-venting tool 300 is plastic, the yield strength and the tensile modulus may be measured according to ASTM D638.

In one embodiment, when the secondary battery is observed in a planar direction (e.g., the Z direction of FIG. 1), a ratio of an area of the corner portion 230 to an area of the accommodating portion 210 may be 0.01 or more, 0.02 or more, 0.03 or more, or 0.05 or more. Further, the area ratio may be 0.15 or less, 0.1 or less, or 0.075 or less. The area of the corner portion 230 may refer to an area of one corner portion 230. Within this range, the venting suppression performance may be further improved.

In one embodiment, when the secondary battery is observed in the planar direction (e.g., the Z direction of FIG. 1), the corner portion 230 may have a triangular shape.

In some embodiments, an minimum angle of the triangle may be between 30° and 45°. If a corner has curved shape, an angle of the corner is assumed to be 90°. If the minimum angle is 45°, remaining two angles that are not 90° may all be minimum angle. In the minimum angular size within the above range, the vent suppression performance may be further improved by dispersing the force applied to the corner portion 230.

In one embodiment, when the secondary battery is observed in the planar direction (e.g., the Z direction in FIG. 1), the anti-venting tool 300 has a width of 0.5 mm or more, 1 mm or more, 2 mm or more, 3 mm or more, or 5 mm or more. Additionally, the width may be 30 mm or less, 20 mm or less, or 10 mm or less.

In some embodiments, the width may be in a range from 1 mm to 10 mm. Within the above range, the venting suppression performance may be improved while maintaining the energy density. The width may be a length of a short side (or short axis) in a shape of the anti-venting mechanism 300 observed in the planar direction.

In one embodiment, when the secondary battery is observed in a lateral direction of the secondary battery (e.g., the X-direction or the Y-direction in FIG. 1), a height of the accommodating portion 210 may be greater than a height of the anti-venting tool 300. The height may be a length measured in the Z-direction of FIG. 1.

In one embodiment, the peripheral part 220 may include four side portions, and each of the four side portions may include a sealing portion. For example, outer circumferential portions of the upper case and the lower case may be sealed (bonded, heat-sealed, etc.) to form the sealing portions at the four side portions.

In one embodiment, the peripheral portion 220 may include a folding portion and the sealing portion. For example, the peripheral portion 220 may include the folding portion formed at one side portion and the sealing portions formed at three side portions. For example, one sheet having a concave portion (corresponding to the accommodating portion) may be folded to form the folding portion, and surfaces facing by the folding of the sheet may be sealed (using an adhesive or heat-sealed) to form the sealing portions at three side portions.

For example, the sealing portions may include a first sealing portion facing the folding portion (e.g., in the Y-direction), and a pair of second sealing portions connected to the folding portion and the first sealing portion.

In some embodiments, the anti-venting tool 300 may be coupled to the sealing portion.

In some embodiments, the anti-venting tool 300 may include a first anti-venting tool coupled across the first sealing portion and the second sealing portion. In this case, the energy density of the secondary battery can be further improved and the venting suppression performance may be more efficiently achieved.

In some embodiments, the anti-venting tool 300 may further include a second anti-venting tool across the folding portion and the second sealing portion.

In one embodiment, the peripheral portion 220 may include a first side 222 and a second side 224 that may be parallel to a long axis direction of the electrode assembly 150 and may face each other; and a third side 226 and a fourth side 228 that may be parallel to a short axis direction of the electrode assembly 150 and may face each other.

The anti-venting tool 300 may be coupled to cross two side portions of the first to fourth sides 222, 224, 226 and 228 that meet each other. In this case, the venting suppression performance may be further improved.

In one embodiment, the secondary battery may further include a cathode lead 107 and an anode lead 127 which may be connected to the electrode assembly 150 and may protrude to an outside of the pouch case 200.

In some embodiments, the cathode lead 107 may protrude from the third side portion 226 and the anode lead 127 may protrude from the fourth side portion 228.

Referring to FIG. 3, the electrode assembly 150 may include a cathode 100 and an anode 130 facing the cathode 100. The electrode assembly 150 may include a plurality of cathodes 100 and a plurality of anodes 130 that are alternately and repeatedly disposed.

In one embodiment, the electrode assembly 150 may further include a separator 140 interposed between the cathode 100 and the anode 130.

The cathode 100 may include a cathode current collector 105 and a cathode active material layer 110 on the cathode current collector 105. The cathode active material layer 110 may be formed on one surface or both surfaces of the cathode current collector 105.

For example, the cathode current collector 105 may include stainless steel, nickel, aluminum, titanium, copper, or an alloy thereof.

For example, the cathode active material layer 110 includes a cathode active material, and may further include a cathode binder and a conductive material.

For example, the cathode active material may include lithium metal oxide particles capable of reversibly intercalating and de-intercalating lithium ions.

In some embodiments, the lithium metal oxide particle may include lithium cobalt-based oxide (LCO) particles, lithium manganese-based oxide (LMO) particles, lithium nickel-based oxide (LNO) particles, lithium nickel-cobalt-manganese-based oxide (NCM) particles, lithium nickel-cobalt-aluminum-based (NCA) oxide particles, lithium iron phosphate-based (LFP) oxide particles, lithium-excess oxide (over-lithiated layered oxide (OLO)) particles, etc.

In one embodiment, the lithium metal oxide particles may further include a coating element or a doping element. For example, the coating element or the doping element may include Al, Ti, Ba, Zr, Si, B, Mg, P, Sr, W, La, an alloy thereof, or an oxide thereof.

In one embodiment, the binder may include an organic binder such as polyvinylidene fluoride (PVDF), vinylidene fluoride-hexafluoropropylene copolymer, polyacrylonitrile, polymethyl methacrylate, etc.; or an aqueous-based binder such as styrene-butadiene rubber (SBR). The binder may be used together with a thickening agent such as carboxymethyl cellulose (CMC).

In one embodiment, the conductive material may include a carbon-based conductive material such as graphite, carbon black, graphene, carbon nanotube (CNT), etc.; or a metal-based conductive material such as tin, tin oxide, titanium oxide, a perovskite material such as LaSrCoO₃ and LaSrMnO₃, etc.

The anode 130 may include an anode current collector 125 and an anode active material layer 120 on the anode current collector 125. The anode active material layer 120 may be formed on one surface or both surfaces of the anode current collector 125.

For example, the anode active material layer 120 may include an anode active material, the binder and the conductive material.

For example, the anode current collector 125 may include gold, stainless steel, nickel, aluminum, titanium, copper, or an alloy thereof.

For example, the anode active material may be a material capable of adsorbing and desorbing lithium ions. For example, the anode active material may include a lithium alloy, a carbon-based active material, a silicon-based active material, etc.

For example, the lithium alloy may further include aluminum, zinc, bismuth, cadmium, antimony, silicon, lead, tin, gallium, indium, etc.

The carbon-based active material may include, e.g., a crystalline carbon, an amorphous carbon, a carbon composite, a carbon fiber, etc.

The amorphous carbon may include, e.g., a hard carbon, cokes, a mesocarbon microbead (MCMB), a mesophase pitch-based carbon fiber (MPCF), etc. The crystalline carbon may include, e.g., artificial graphite, natural graphite, graphitized coke, graphitized MCMB, graphitized MPCF, etc.

For example, the silicon-based active material may include Si, SiOₓ(0<x<2), Si/C, SiO/C, Si-metal, etc.

In some embodiments, an area of the anode 130 may be greater than that of the cathode 100.

In one embodiment, the cathode current collector 105 may include a cathode tab (not illustrated) protruding at one side thereof.

For example, the cathode tab may be integral with the cathode current collector 105 or may be electrically connected to the cathode current collector 105 by, e.g., welding. The cathode active material layer 110 may not be formed on the cathode tab. The cathode current collector 105 and the cathode lead 107 may be electrically connected via the cathode tab.

In one embodiment, the anode current collector 125 may include an anode tab (not illustrated) protruding at one side thereof. The anode tab may be integral with the anode current collector 125 or may be connected to the anode current collector 125 by, e.g., welding. The anode active material layer 120 may not be formed on the anode tab. The anode electrode current collector 125 and the anode lead 127 may be electrically connected via the anode tab.

For example, the separator 140 may include a porous polymer film prepared from, e.g., a polyolefin-based polymer such as an ethylene homopolymer, a propylene homopolymer, an ethylene/butene copolymer, an ethylene/hexene copolymer, an ethylene/methacrylate copolymer, etc. The separator 140 may also include a non-woven fabric formed from a glass fiber with a high melting point, a polyethylene terephthalate fiber, etc.

In one embodiment, the electrode assembly 150 may be accommodated together with an electrolyte in a case 160 to form the lithium secondary battery. For example, the electrolyte may include a lithium salt and an organic solvent.

The lithium salt may be represented by Li⁺X⁻. For example, the anion X⁻ may be any one selected from F⁻, Cl⁻, Br⁻, I⁻, NO₃⁻, N(CN)₂⁻, BF₄⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻ and (CF₃CF₂SO₂)₂N⁻.

In one embodiment, the organic solvent may include a carbonate-based solvent such as ethylene carbonate (EC), propylene carbonate (PC), dimethyl carbonate (DMC), diethyl carbonate (DEC), ethyl methyl carbonate (EMC), etc.; an ester-based solvent such as methyl propionate, ethyl propionate, ethyl acetate, propyl acetate, butyl acetate, butyrolactone, caprolactone, valerolactone, etc.; an ether-based solvent such as dibutyl ether, tetraethylene glycol dimethyl ether (TEGDME), diethylene glycol dimethyl ether (DEGDME), tetrahydrofuran (THF), etc.; an alcohol-based solvent such as ethyl alcohol, isopropyl alcohol, etc.; a ketone-based solvent such as cyclohexanone; an aprotic solvent such as an amide-based solvent (e.g., dimethylformamide), a dioxolane-based solvent (e.g., 1,3-dioxolane), a sulfolane-based solvent, a nitrile-based solvent, etc.

Hereinafter, preferred embodiments are proposed to more concretely describe the present inventive concepts. However, the following examples are only given for illustrating the present inventive concepts and those skilled in the related art will obviously understand that various alterations and modifications are possible within the scope and spirit of the present disclosures. Such alterations and modifications are duly included in the appended claims

### Example 1

A cathode slurry was prepared by mixing LiNi_{0.8}Co_{0.1}Mn_{0.1}O₂, carbon black and PVDF in a weight ratio of 92:5:3. The cathode slurry was coated on an area except for a protrusion of an aluminum thin film (thickness: 12 μm) having the protrusion (hereinafter, a cathode tab) at one side thereof, and dried and pressed to prepare a cathode.

An anode slurry was prepared by mixing natural graphite, SBR, CMC and flake-type amorphous graphite in a weight ratio of 92:3:1:5. The anode slurry was coated on an area except for a protrusion of a copper thin film (thickness: 8 μm) having the protrusion (hereinafter, an anode tab) at one side thereof, and then dried and pressed to form the anode.

An electrode assembly was manufactured by interposing a polyethylene separator having a thickness of 25 μm between the cathode and the anode. A cathode lead and an anode lead were connected to the cathode tab and the anode tab, respectively.

The electrode assembly was housed in a pouch case having sealing portions at four sides, and three sides were sealed. The electrolyte was injected through a remaining side (injection side), and the injection side was sealed.

An anti-venting tool having the shape of FIG. 5 (using SUS having a yield strength of 215 MPa) was prepared, and coupled to each corner of the pouch case as illustrated in FIG. 2.

A 1M LiPF₆ solution (EC/EMC/DEC mixed solvent in a volume ratio of 25:45:30) was used as the electrolyte.

### Comparative Example 1

A secondary battery was manufactured by the same method as that in Example 1, except that the anti-venting tool was not combined.

### Comparative Example 2

As illustrated in FIG. 6, an anti-venting tool that entirely surrounded the sealing portions parallel to a long axis direction of the electrode assembly was prepared.

A secondary battery was manufactured by the same method as that in Example 1, except that the above anti-venting tool was combined.

### Evaluation Example 1: 60° C. High Temperature Storage Evaluation

The secondary batteries of Example and Comparative Examples were CC/CV charged (0.3C, 4.2V, 0.05C CUT OFF) to a SOC (State of Charge) 100% state.

The charged secondary batteries were each left in a constant temperature apparatus (60° C. and atmospheric conditions).

A period at which a venting occurred in the pouch case was confirmed. It was evaluated as the venting occurred when a periphery of the pouch case (i.e., the sealing portion) was inflated or a gas discharge hole was formed.

TABLE 1

| | | Comparative | Comparative |
|---|---|---|---|
| | Example 1 | Example 1 | Example 2 |
| venting | 22 Weeks | 16 Weeks | 24 Weeks |
| occurring | | | |
| period | | | |

Referring to Table 1, the venting suppression performance of the secondary battery of Example 1 was improved compared to that of Comparative Example 1.

Additionally, the secondary battery of Example 1 provided the venting suppression performance similar to that of the lithium secondary battery of Comparative Example 2 (see FIG. 6). Therefore, according to the result of Example 1, high energy density can be obtained while improving the venting suppression performance.

What is claimed is:

1. A secondary battery, comprising:
an electrode assembly comprising a cathode and an anode;
a pouch case comprising an accommodating portion in which the electrode assembly is placed, and a peripheral portion extending along a circumference of the accommodating portion and sealing the electrode assembly; and
an anti-venting tool coupled to at least one corner portion among corner portions of the peripheral portion to fix the corner portion,
wherein the corner portion is inserted through the anti-venting tool to protrude from the anti-venting tool.

2. The secondary battery of claim 1, wherein the anti-venting tool is coupled to each of the corner portions.

3. The secondary battery of claim 1, wherein the peripheral portion comprises:
a first side and a second side that are parallel to a long axis direction of the electrode assembly to face each other; and
a third side and a fourth side that are parallel to a short axis direction of the electrode assembly to face each other,
wherein the anti-venting tool crosses two sides meeting each other among the first side to the fourth side in a planar direction.

4. The secondary battery of claim 1, wherein the peripheral portion comprises a folding portion and a sealing portion, and
the anti-venting tool comprises a first anti-venting tool coupled to the sealing portion.

5. The secondary battery of claim 4, wherein the sealing portion comprises a first sealing portion facing the folding portion, and a pair of second sealing portions connected to the folding portion and the first sealing portion, and
the first anti-venting tool is coupled across the first sealing portion and the second sealing portion.

6. The secondary battery of claim 5, wherein the anti-venting tool further comprises a second anti-venting tool coupled across the folding portion and the second sealing portion.

7. The secondary battery of claim 1, wherein a ratio of an area of the corner portion to an area of the accommodating portion in a planar direction ranges from 0.02 to 0.15.

8. The secondary battery of claim 1, wherein the corner portion has a triangle shape in a planar direction, and a minimum angle of the triangle is in a range from 30° to 45°.

9. The secondary battery of claim 1, wherein a width of the anti-venting tool in a planar direction is in a range from 1 mm to 10 mm.

10. The secondary battery of claim 1, wherein a height of the accommodating portion is greater than a height of the anti-venting tool.

11. The secondary battery of claim 1, wherein the anti-venting tool comprises an upper supporting portion, a lower supporting portion facing the upper supporting portion, and a connector connecting one end of the upper supporting portion and one end of the lower supporting portion, and
the corner portion protrudes while being sandwiched between the upper supporting portion and the lower supporting portion.

12. The secondary battery of claim 1, wherein the anti-venting tool comprises an upper supporting portion, a lower supporting portion facing the upper supporting portion, a first connector connecting one end of the upper supporting portion and one end of the lower supporting portion, and a second connector connecting the other end of the upper supporting portion and the other end of the lower supporting portion, and
the corner portion protrudes while being sandwiched between the upper supporting portion and the lower supporting portion.

13. The secondary battery of claim 1, wherein the anti-venting tool has a yield strength from 0.5 MPa to 500 MPa.

14. The secondary battery of claim 1, wherein the anti-venting tool has a tensile modulus from 1 GPa to 500 GPa.
